(19) United States
(12) Patent Application Publication
(10) Pub. No.: US 2012/0086882 A1
(43) Pub. Date: Apr. 12, 2012

(54) BACKLIGHT CHASSIS AND LIQUID CRYSTAL DISPLAY DEVICE PROVIDED WITH SAME

(75) Inventor: Kohji Itoh, Osaka-shi (JP)

(73) Assignee: SHARP KABUSHIKI KAISHA, Osaka-shi, Osaka (JP)

(21) Appl. No.: 13/378,102

(22) PCT Filed: Mar. 16, 2010
(86) PCT No.: PCT/JP2010/054394

§ 371 Date: Dec. 14, 2011

(30) Foreign Application Priority Data
Jul. 9, 2009 (JP) 2009-162714

(51) Int. Cl. G02F 1/1333; G09F 13/04

(52) U.S. Cl. 349/58; 362/633; 362/612

(57) ABSTRACT

Provided is a backlight chassis which has a reduced weight, while ensuring sufficient rigidity and heat dissipation. The backlight chassis having a light source unit mounted thereon is configured with the combination of a resin member and a highly rigid and highly heat conductive member which has a rigidity and heat conductivity higher than those of the resin member.

### TECHNICAL FIELD

The present invention relates to a liquid crystal display device, and specifically relates to a backlight chassis on which a light source unit is mounted.

### BACKGROUND ART

Today's flat-screen televisions typified by liquid crystal televisions are growing in size. This, however, also leads to their weight increase, and from the viewpoint that they may be transported or hung on a wall, there has been a demand for their weight reduction. Various propositions have been made regarding this issue of weight reduction.

For example, Patent Document 1 discloses a housing for a large-sized display that uses a material having a high bending elastic modulus so as to have improved rigidity and thus to reduce the need for a rib and a reinforcing portion and has a reduced thickness, thereby being reduced in weight.

### LIST OF CITATIONS

### Patent Literature

Patent Document 1: JP-A-H11-272198

### SUMMARY OF THE INVENTION

### Technical Problem

Patent Document 1 mentioned above seeks to achieve weight reduction of the housing for a large-sized display. As far as a liquid crystal display device is concerned, however, what actually accounts for a large percentage of its weight is a backlight chassis made of metal. The reason why a backlight chassis is made of metal is that the chassis should have rigidity for holding a backlight and so on and a heat radiation property for releasing heat of the backlight.

Hence, there has conventionally been a problem that, in seeking to achieve weight reduction of a backlight chassis, the use of a material having a reduced thickness fails to provide sufficient rigidity, and the use of a material lighter than metal fails to provide a sufficient heat radiation property.

It is an object of the present invention to provide a backlight chassis that achieves weight reduction while securing sufficient rigidity and a sufficient heat radiation property. Furthermore, it is also an object of the present invention to provide a liquid crystal display device that is provided with the backlight chassis and thereby achieves weight reduction.

### Solution to the Problem

In order to achieve the above-described objects, the present invention provides a backlight chassis for mounting a light source unit thereon. The backlight chassis is made up of a resin member in combination with a highly rigid and highly thermally conductive member having higher rigidity and higher thermal conductivity than those of the resin member.

According to the above-described configuration, a backlight chassis, which is conventionally made of metal, is formed partly of a resin member so as to be reduced in weight and partly of a highly rigid and highly thermally conductive member so that the rigidity and heat radiation property thereof, which are deteriorated as a result of use of the resin member, are improved.

In the above-described backlight chassis, preferably, the highly rigid and highly thermally conductive member is provided at a part of the backlight chassis with which the light source unit comes in contact. This is preferable in that, since the light source unit generates most heat, the member having high thermal conductivity is used to constitute a part of the backlight chassis with which the light source unit comes in direct contact, and thus an improved heat radiation property can be obtained.

Furthermore, in the above-described backlight chassis, preferably, the highly rigid and highly thermally conductive member is provided so as to penetrate through the backlight chassis. This is preferable in terms of efficiency since heat in the backlight chassis is transmitted through the highly rigid and highly thermally conductive member to be radiated from a rear surface of the highly rigid and highly thermally conductive member to the outside of the backlight chassis.

Furthermore, in the above-described backlight chassis, from the viewpoint of obtaining an improved heat radiation property, preferably, a surface of the highly rigid and highly thermally conductive member exposed to an outer side of the backlight chassis is formed so as to be in a fin configuration.

Furthermore, in the above-described backlight chassis, as a light source of the light source unit, an LED that generates a reduced amount of heat can be used.

Furthermore, the above-described backlight chassis can be applied to either of a case where the light source unit is disposed based on a direct method and a case where the light source unit is disposed based on an edge light method.

Furthermore, in the above-described backlight chassis, preferably, a concave portion or a convex portion is provided on a joint surface between the highly rigid and highly thermally conductive member and the resin member, and the highly rigid and highly thermally conductive member is molded integrally with the resin member. This is preferable in that the resin member is formed so as to penetrate into side portions of the convex portion or into the concave portion and thus increased adhesion strength is provided, so that a tough backlight chassis is obtained.

Furthermore, in the above-described backlight chassis, from the viewpoint of obtaining improved rigidity, preferably, the highly rigid and highly thermally conductive member is bend-processed.

Furthermore, in the above-described backlight chassis, from the viewpoint of securing rigidity with a less amount of the highly rigid and highly thermally conductive member used, preferably, the highly rigid and highly thermally conductive member is provided at least in a shape formed along an outer periphery of a bottom surface of the backlight chassis.

Furthermore, in the above-described backlight chassis, disposing the highly rigid and highly thermally conductive member in a striped lattice form is preferable from the viewpoint of a heat radiation property since, with this configuration, particularly in a case where the direct method is adopted, the highly rigid and highly thermally conductive member is situated directly below the light source unit.

Furthermore, in the above-described backlight chassis, providing an opening at a region enclosed by the highly rigid and highly thermally conductive member enables further weight reduction.

Furthermore, a liquid crystal display device according to the present invention is configured to be provided with the backlight chassis having any of the above-described configurations.

### Advantageous Effects of the Invention

According to the present invention, a backlight chassis is made up of a resin member and a highly rigid and highly thermally conductive member, and thus compared with a conventional metallic backlight chassis, weight reduction can be achieved while sufficient rigidity and a sufficient heat radiation property are secured.

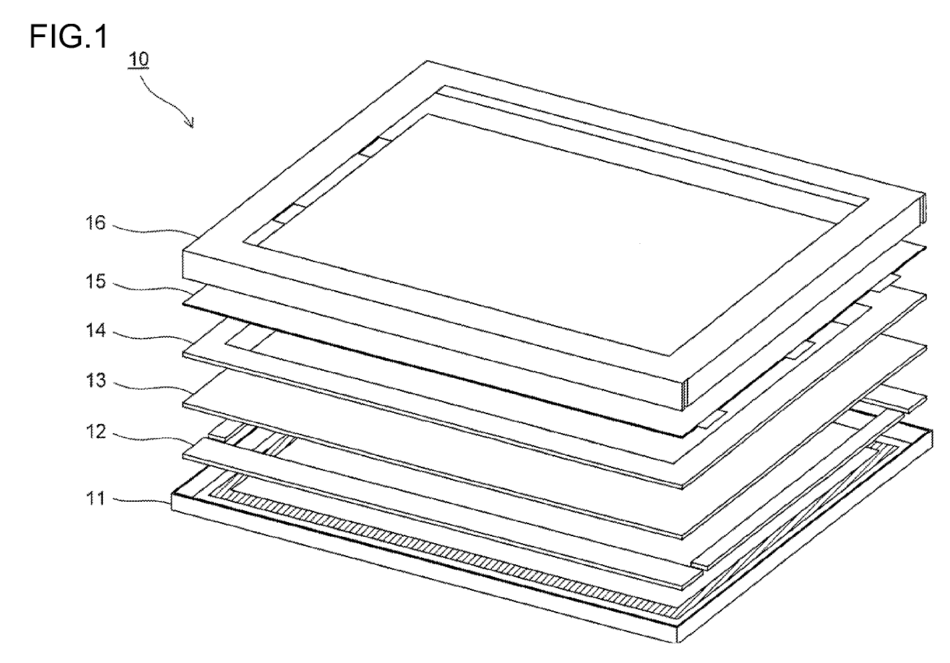

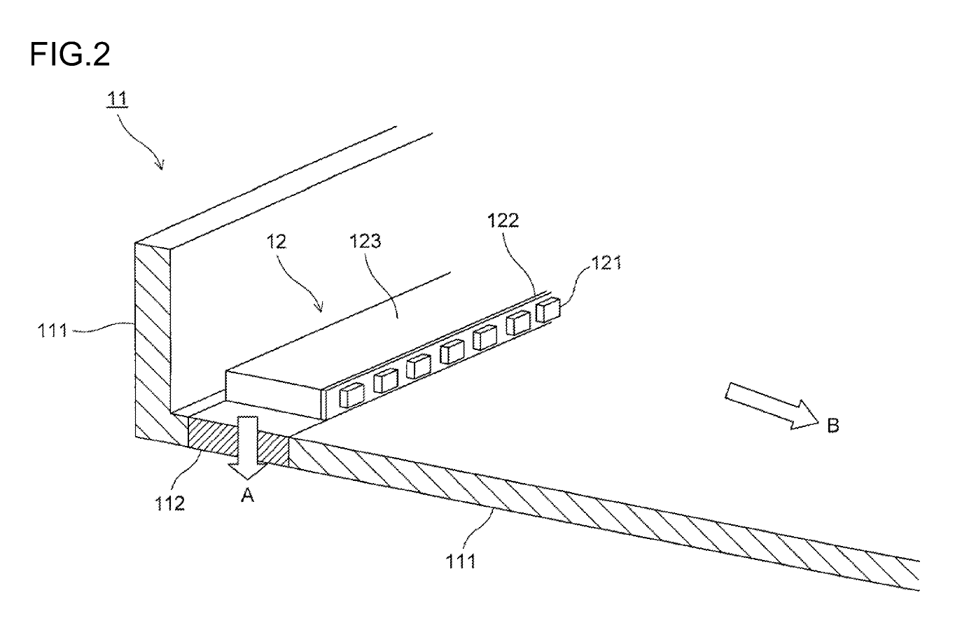

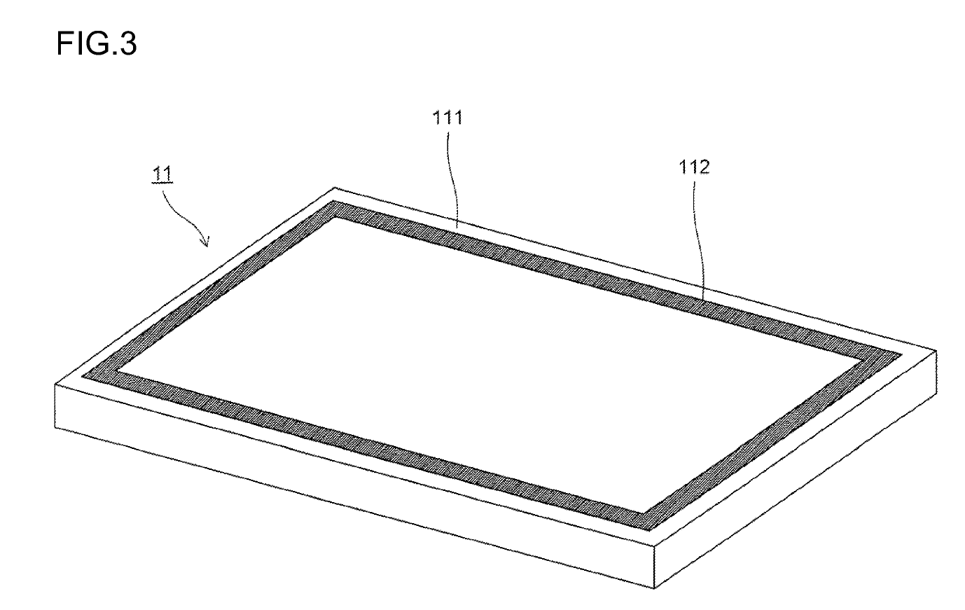

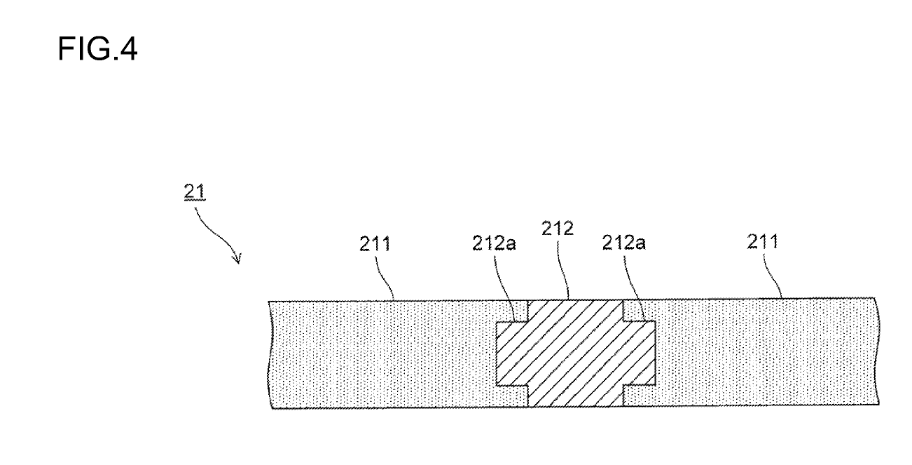

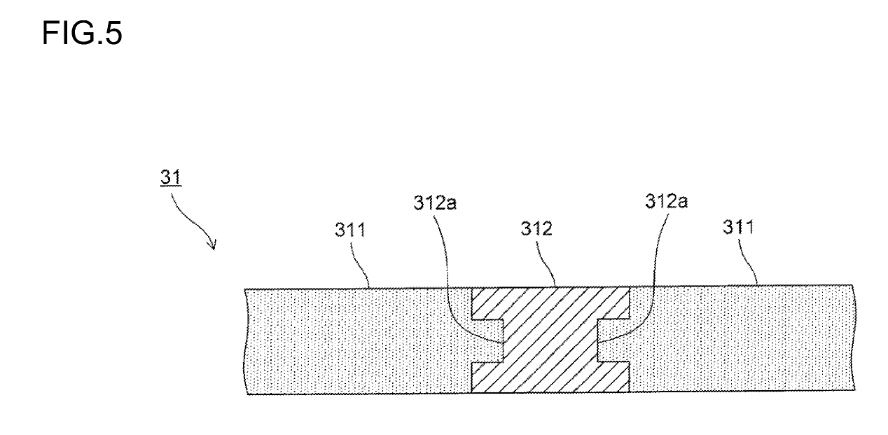

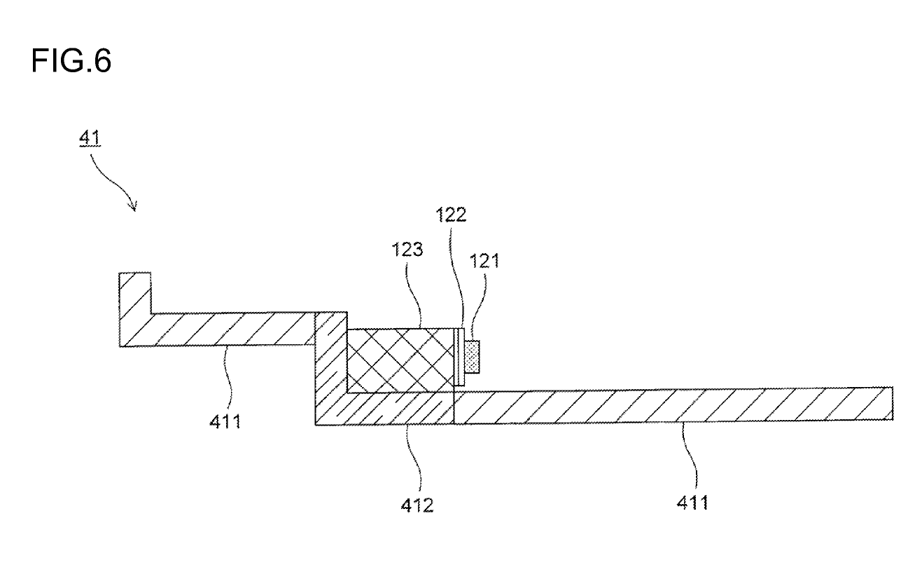

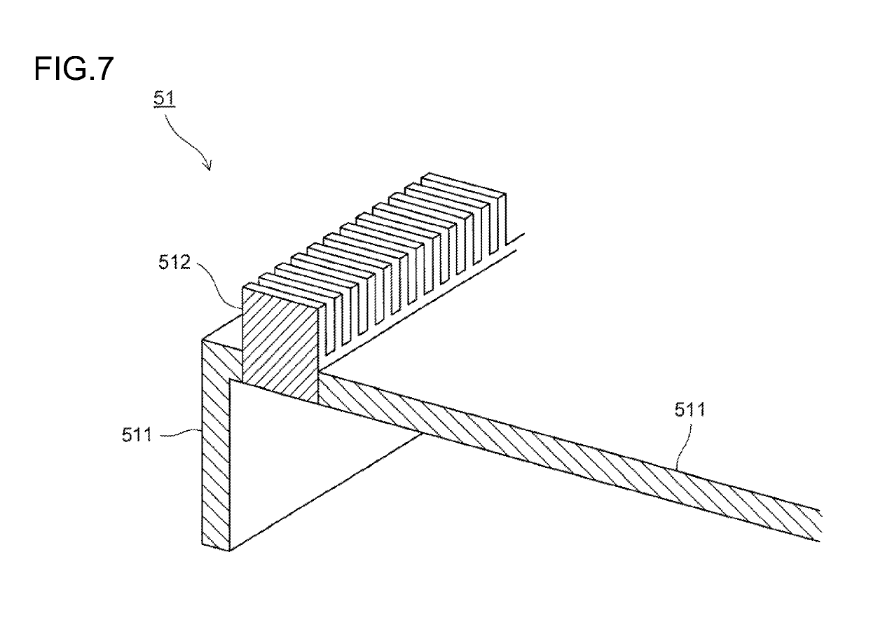

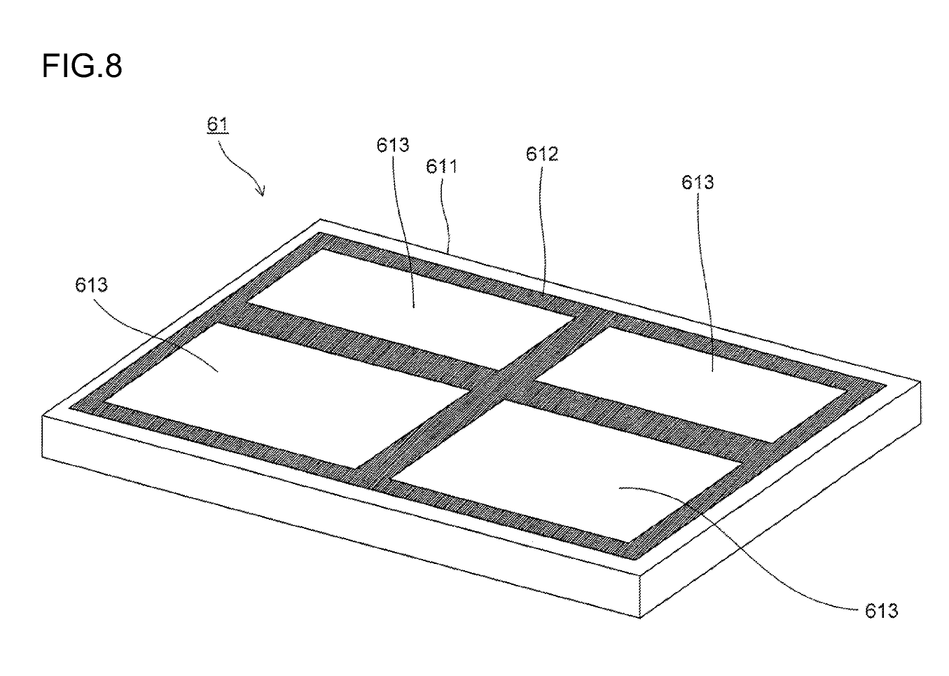

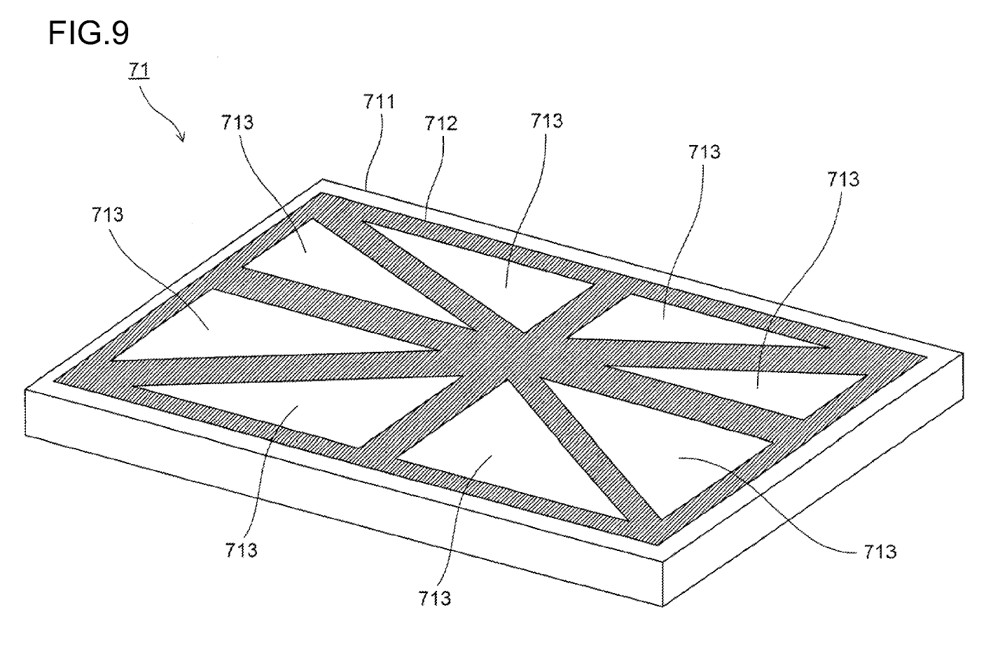

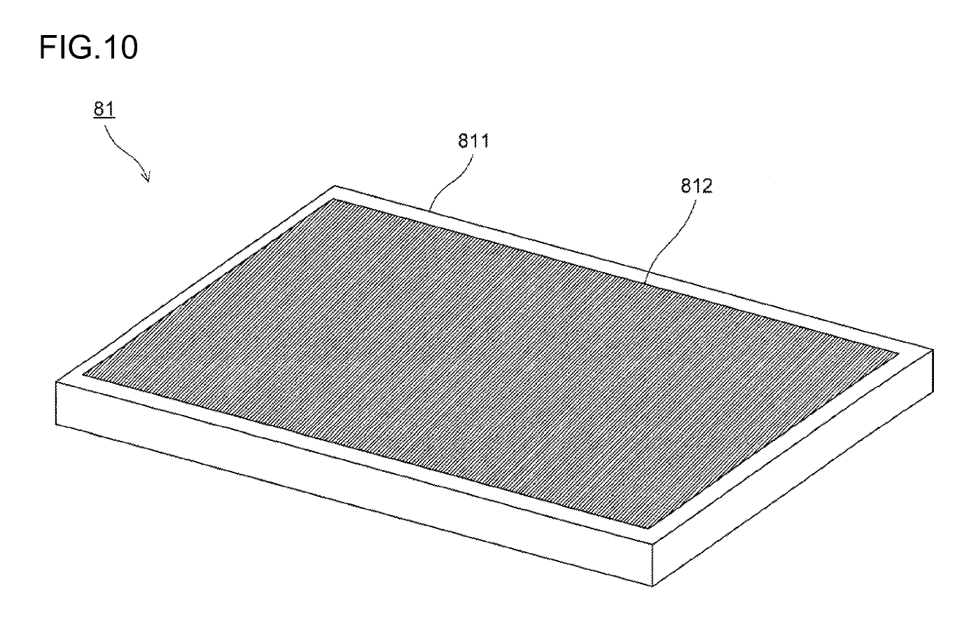

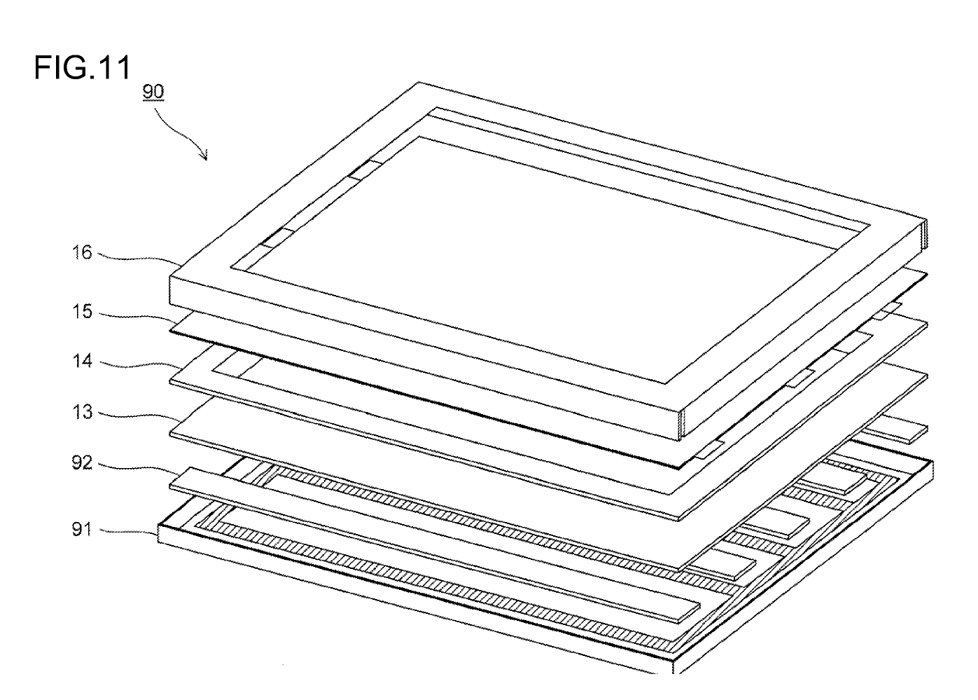

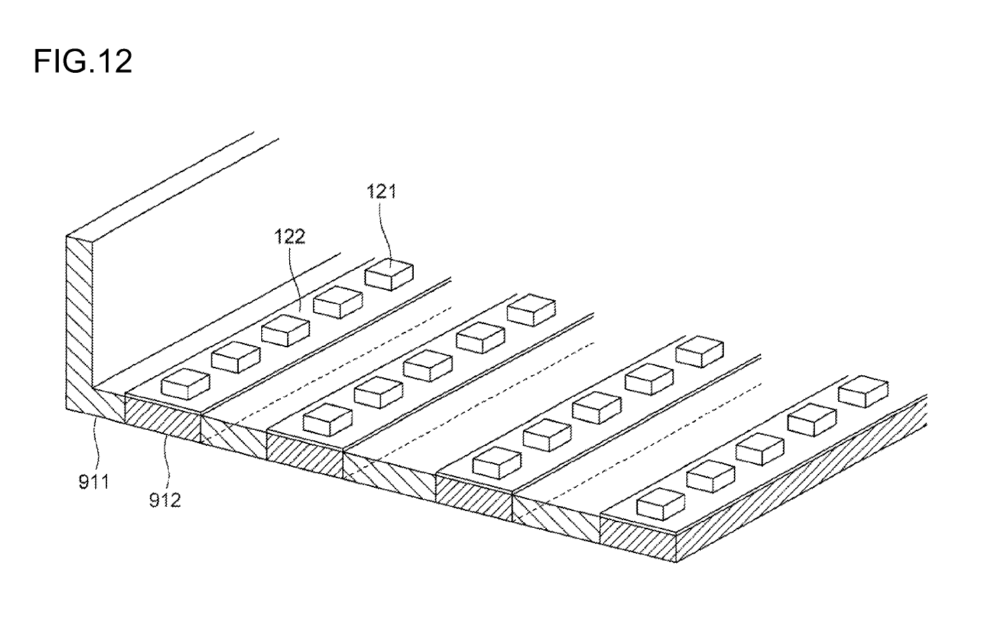

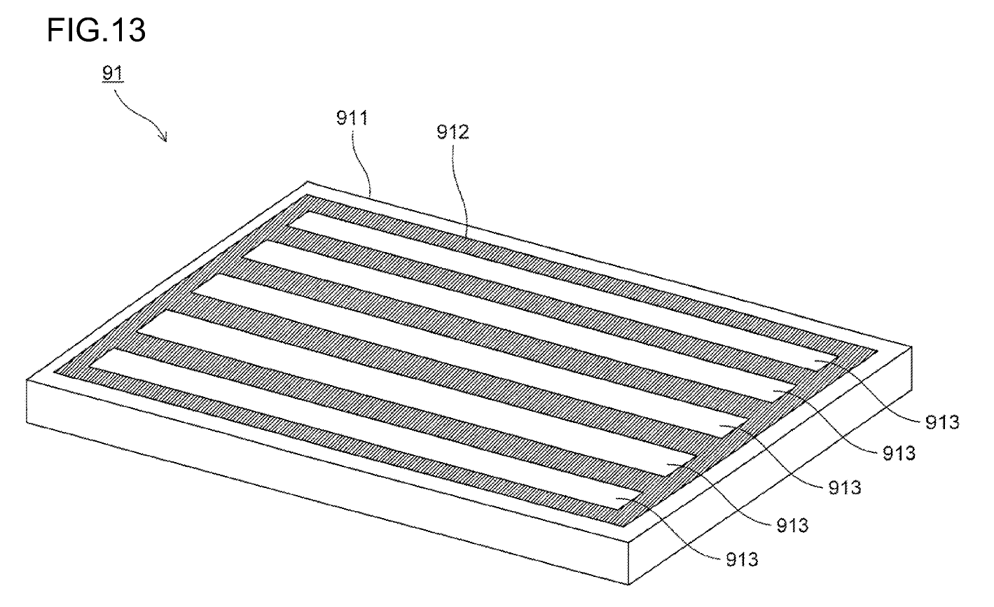

### BRIEF DESCRIPTION OF DRAWINGS

[FIG. 1] is an exploded perspective view of a liquid crystal display device according to the present invention.

[FIG. 2] is a partial cross-sectional view of a backlight chassis shown in FIG. 1, which has a light source unit mounted thereon.

[FIG. 3] is a perspective view of a rear surface of the backlight chassis shown in FIG. 1.

[FIG. 4] is a partial cross-sectional view of a backlight chassis for explaining a cross-sectional shape of a highly rigid and highly thermally conductive member according to the present invention, which improves adhesion strength.

[FIG. 5] is a partial cross-sectional view of a backlight chassis for explaining a cross-sectional shape of a highly rigid and highly thermally conductive member according to the present invention, which improves adhesion strength.

[FIG. 6] is a partial cross-sectional view of a backlight chassis for explaining a bend-processed highly rigid and highly thermally conductive member according to the present invention.

[FIG. 7] is a partial cross-sectional view of a backlight chassis for explaining a highly rigid and highly thermally conductive member having a fin configuration according to the present invention.

[FIG. 8] is a perspective view of a rear surface of a backlight chassis according to another embodiment of the present invention.

[FIG. 9] is a perspective view of a rear surface of a backlight chassis according to still another embodiment of the present invention.

[FIG. 10] is a perspective view of a rear surface of a backlight chassis according to yet still another embodiment of the present invention.

[FIG. 11] is an exploded perspective view of another liquid crystal display device according to the present invention.

[FIG. 12] is a partial cross-sectional view of a backlight chassis shown in FIG. 11, which has a light source unit mounted thereon.

[FIG. 13] is a perspective view of a rear surface of the backlight chassis shown in FIG. 11.

### DESCRIPTION OF EMBODIMENTS

FIG. 1 is an exploded perspective view of a liquid crystal display device according to the present invention. FIG. 2 is a partial cross-sectional view of a backlight chassis having a light source unit mounted thereon. FIG. 3 is a perspective view of a rear surface of the backlight chassis. A liquid crystal display device 10 described here can be used as a display of a television or of a computer. The liquid crystal display device 10 includes a backlight chassis 11, a light source unit 12, an optical member 13, a panel frame 14, a panel 15, and a bezel 16.

The backlight chassis 11 is a member functioning as a base for mounting thereon backlight members such as the light source unit 12 and the optical member 13 and has a box shape. A detailed configuration of the backlight chassis 11 will be described later. As for a conventional backlight chassis, in order to secure rigidity and a heat radiation property, SECC (steel plate), Al, or the like is used as a material thereof.

As shown in FIG. 2, the light source unit 12 includes an LED 121 that is a light source, an LED substrate 122 on which the LED 121 is mounted, and an LED substrate fixing plate 123 on which the LED substrate 122 is placed and that is used to fix the LED 121 to the backlight chassis 11 at a predetermined angle. Although here, the light source unit 12 is disposed based on an edge light method, it may be disposed based on a direct method instead. Furthermore, although here, four light source units 12 are provided along the outer periphery of a bottom surface of the backlight chassis 11, respectively, a configuration using two or one light source unit(s) 12 may be adopted instead.

The optical member 13 is formed of, for example, a diffusion member that diffuses light of the LED 121 and irradiates the panel 15 with uniform light.

The panel frame 14 is a member that holds the panel 15, and as the panel frame 14, a frame made of a resin such as PC (polycarbonate) is used.

The panel 15 is a member formed by injecting liquid crystal between two transparent substrates and displays a video image by driving the liquid crystal.

The bezel 16 is a frame-shaped member for fixing the panel 15 by applying pressure thereto and is fitted over the box-shaped backlight chassis 11 in a lid-like manner. Although a conventional bezel is made of SECC (steel plate), Al, or the like, here, in order to achieve weight reduction, any of PC (polycarbonate), ABS resins, CFRPs (carbon fiber reinforced plastics), and the like is used as a material of the bezel 16. In order to achieve further weight reduction, the bezel 16 may be made of any of these materials and molded integrally with a housing (not shown) forming an exterior.

The following describes the detailed configuration of the backlight chassis 11. As shown in FIGS. 1 to 3, the backlight chassis 11 is made up of a resin member 111 in combination with a highly rigid and highly thermally conductive member 112 having higher rigidity and higher thermal conductivity than those of the resin member 111. The backlight chassis 11 can be set to have a thickness of, for example, 0.8 to 1.0 mm In FIGS. 1 and 3, though they are not cross-sectional views, the highly rigid and highly thermally conductive member 112 is shown by hatching for ease of viewing.

The resin member 111 is used to constitute a large part of the backlight chassis 11, so that, compared with a conventional metallic backlight chassis, weight reduction is achieved to a considerable degree. As a material of the resin member 111, any of PC, ABS resins, CFRPs, and the like can be used.

For example, as shown in FIGS. 1 to 3, the highly rigid and highly thermally conductive member 112 is provided in a shape formed along the outer periphery of the bottom surface of the backlight chassis 11, so that the rigidity and heat radiation property of the backlight chassis 11, which are deteriorated as a result of use of the resin member 111, are improved. As a material of the highly rigid and highly thermally conductive member 112, any of Fe, Al, CFRPs, and the like can be used.

From the viewpoint of a heat radiation property, it is desirable that, as shown in FIG. 2, the highly rigid and highly thermally conductive member 112 be provided so as to penetrate through the backlight chassis 11. This is desirable in terms of efficiency since heat in the backlight chassis 11 is transmitted through the highly rigid and highly thermally conductive member 112 in a perpendicular direction as indicated by an arrow A to be radiated from a rear surface of the highly rigid and highly thermally conductive member 112.

Furthermore, since the LED 121 generates most heat, it is desirable that the highly rigid and highly thermally conductive member 112 be provided at a part of the backlight chassis 11 with which the LED substrate fixing plate 123 on which the LED substrate 122 is fixed comes in contact. Specifically, with the highly rigid and highly thermally conductive member 112 provided as shown in FIG. 2, heat generated from the LED 121 is transmitted to the LED substrate fixing plate 123 via the LED substrate 122 and is then transmitted therefrom to the highly rigid and highly thermally conductive member 112 and through the highly rigid and highly thermally conductive member 112 in the perpendicular direction as indicated by the arrow A to be radiated from the rear surface of the highly rigid and highly thermally conductive member 112.

Even in a case where the LED substrate fixing plate 123 is fixed on the resin member 111, heat generated from the LED 121 is transmitted to the LED substrate fixing plate 123 via the LED substrate 122 and is then transmitted therefrom to the resin member 111. The heat is then transmitted through the surface of the resin member 111 in a plane direction (direction indicated by an arrow B in FIG. 2) while being radiated to some extent. The heat is further transmitted to the highly rigid and highly thermally conductive member 112 and through the highly rigid and highly thermally conductive member 112 in the perpendicular direction (direction indicated by the arrow A) to be radiated from the rear surface of the highly rigid and highly thermally conductive member 112.

The backlight chassis 11 can be manufactured by, for example, a method in which the highly rigid and highly thermally conductive member 112 is disposed in a mold for shaping the backlight chassis 11, and the resin member 111 at a high temperature is poured into the mold so that the highly rigid and highly thermally conductive member 112 and the resin member 111 are molded integrally with each other. Thus, compared with a case where these are fixed to each other by use of a screw or the like, connection strength is increased, and production efficiency is also improved.

In the above-described case where the backlight chassis 11 is integrally molded, by appropriately shaping the highly rigid and highly thermally conductive member, adhesion strength between the highly rigid and highly thermally conductive member and the resin member is increased. Each of FIGS. 4 and 5 is a cross-sectional view of a backlight chassis for explaining a cross-sectional shape of a highly rigid and highly thermally conductive member that improves adhesion strength.

In FIG. 4, a highly rigid and highly thermally conductive member 212 has a cross-sectional shape of a rectangle with convex portions 212a and 212a formed on both sides thereof, respectively. Thus, a resin member 211 is formed so as to penetrate into side portions of the convex portions 212a, and thus increased adhesion strength is provided, so that a tough backlight chassis 21 is obtained.

On the other hand, in FIG. 5, a highly rigid and highly thermally conductive member 312 has a cross-sectional shape of a rectangle with concave portions 312a and 312a formed on both sides thereof, respectively. Thus, a resin member 311 is formed so as to penetrate into the concave portions 312a, and thus increased adhesion strength is provided, so that a tough backlight chassis 31 is obtained. In addition to these shapes, shapes that increase the area of a joint surface of the highly rigid and highly thermally conductive member can also be adopted since they provide increased adhesion strength.

Furthermore, bend-processing the highly rigid and highly thermally conductive member can further increases the strength thereof. FIG. 6 is a partial cross-sectional view of a backlight chassis 41 for explaining a bend-processed highly rigid and highly thermally conductive member 412. The highly rigid and highly thermally conductive member 412 provided in a shape formed along the outer periphery of a bottom surface of the backlight chassis 41 has an L-shape in cross section. Instead of being formed in an L-shape, the highly rigid and highly thermally conductive member 412 may be formed so as to be stepped by being bent plural times in bend-processing. When bend-processed, the highly rigid and highly thermally conductive member 412 becomes less likely to be distorted by an external force, as a result of which the rigidity of the backlight chassis 41 is improved.

The LED substrate fixing plate 123 is fixed to be in contact with a bottom surface and a side surface of the highly rigid and highly thermally conductive member 412 on the inner side of the L-shape. Thus, compared with an embodiment shown in FIG. 2, a contact area between the LED substrate fixing plate 123 and the highly rigid and highly thermally conductive member 412 is increased, and thus an improved heat radiation property is also obtained.

Furthermore, forming the highly rigid and highly thermally conductive member so that it has a fin configuration can enhance the heat radiation property thereof. FIG. 7 is a partial cross-sectional view of a backlight chassis 51 for explaining a highly rigid and highly thermally conductive member 512 having a fin configuration. A surface of the highly rigid and highly thermally conductive member 512 exposed to the outer side of the backlight chassis 51 is formed so as to be in the fin configuration. Thus, compared with the embodiment shown in FIG. 2, a surface area of the highly rigid and highly thermally conductive member 512 is increased, and thus a further improved heat radiation property is obtained.

Furthermore, without any limitation to a disposition shown in FIG. 3, the highly rigid and highly thermally conductive member is disposed in any of various possible forms. For example, dispositions shown in FIGS. 8 to 10 may be adopted. Each of FIGS. 8 to 10 is a perspective view of a rear surface of a backlight chassis according to each of other embodiments. In FIGS. 8 to 10, though they are not cross-sectional views, the highly rigid and highly thermally conductive member is shown by hatching for ease of viewing.

In FIG. 8, a highly rigid and highly thermally conductive member 612 is provided in a shape formed along the outer periphery of a bottom surface of a backlight chassis 61 and, inside the shape, it further extends in a cross shape and thus has a two-by-two matrix shape. Thus, the rigidity and heat radiation property of the backlight chassis 61, which are deteriorated as a result of use of a resin member 661, are improved.

An opening 613 is provided at each of regions enclosed by the highly rigid and highly thermally conductive member 612. That is, four rectangular regions formed in the two-by-two matrix shape are provided in the form of through openings. In a case where the edge light method is adopted, since the light source units 12 can be provided on a part of the highly rigid and highly thermally conductive member 612 having the shape formed along the outer periphery of the bottom surface of the backlight chassis 61, the presence of the opening 613 poses no problem. With the opening 613 provided, the use amount of the resin member 611 can be reduced by an amount defined by the opening 613, and thus further weight reduction can be achieved.

In FIG. 9, a highly rigid and highly thermally conductive member 712 is provided in a shape formed along the outer periphery of a bottom surface of a backlight chassis 71 and, inside the shape, it further extends in a shape of two crosses superposed on each other. Thus, by the highly rigid and highly thermally conductive member 712 used in an amount larger than in a case shown in FIG. 8, further improved rigidity and a further improved heat radiation property are obtained.

Similarly to the case shown in FIG. 8, an opening 713 is provided at each of regions enclosed by the highly rigid and highly thermally conductive member 712. With the opening 713 provided, the use amount of a resin member 711 can be reduced by an amount defined by the opening 713, and thus further weight reduction can be achieved.

In FIG. 10, a highly rigid and highly thermally conductive member 812 is provided on substantially an entire bottom surface of a backlight chassis 81. Thus, by the highly rigid and highly thermally conductive member 812 used in an amount larger than the use amount of a resin member 811, further improved rigidity and a further improved heat radiation property are obtained.

Next, the following describes one example of a direct type liquid crystal display device. FIG. 11 is an exploded perspective view of another liquid crystal display device according to the present invention. FIG. 12 is a partial cross-sectional view of a backlight chassis shown in FIG. 11, which has a light source unit mounted thereon. FIG. 13 is a perspective view of a rear surface of the backlight chassis shown in FIG. 11. A liquid crystal display device 90 described here is different from the foregoing liquid crystal display device 10 in that a light source is disposed based on the direct method. The liquid crystal display device 90 includes a backlight chassis 91, a light source unit 92, an optical member 13, a panel frame 14, a panel 15, and a bezel 16. In the following, members having the same functions as those of the corresponding members in the foregoing liquid crystal display device 10 are indicated by like reference symbols, and detailed descriptions thereof are omitted.

The backlight chassis 91 is a member functioning as a base for mounting thereon backlight members such as the light source unit 92 and the optical member 13 and has a box shape. A detailed configuration of the backlight chassis 91 will be described later.

As shown in FIG. 12, the light source unit 92 includes an LED 121 that is a light source and an LED substrate 122 on which the LED 121 is mounted. Here, the LED substrate 122 is used for fixing to the backlight chassis 91. Furthermore, although here, a plurality of linear light source units 92 are provided in parallel on a bottom surface of the backlight chassis 11, there is no particular limitation on the disposition of the light source units 92 as long as they are provided on the bottom surface of the backlight chassis 11.

The following describes the detailed configuration of the backlight chassis 91. As shown in FIGS. 11 to 13, the backlight chassis 91 is made up of a resin member 911 in combination with a highly rigid and highly thermally conductive member 912 having higher rigidity and higher thermal conductivity than those of the resin member 911. In FIGS. 11 and 13, though they are not cross-sectional views, the highly rigid and highly thermally conductive member 912 is shown by hatching for ease of viewing.

The resin member 911 is used to constitute a large part of the backlight chassis 11, so that, compared with a conventional metallic backlight chassis, weight reduction is achieved to a considerable degree. As a material of the resin member 911, any of PC, ABS resins, CFRPs, and the like can be used.

For example, as shown in FIGS. 11 to 13, the highly rigid and highly thermally conductive member 912 is disposed in a striped lattice form on the bottom surface of the backlight chassis 91, so that the rigidity and heat radiation property of the backlight chassis 11, which are deteriorated as a result of use of the resin member 911, are improved. As a material of the backlight chassis 11, any of Fe, Al, CFRPs, and the like can be used.

From the viewpoint of a heat radiation property, it is desirable that, as shown in FIG. 12, the highly rigid and highly thermally conductive member 912 be provided so as to penetrate through the backlight chassis 91. This is desirable in terms of efficiency since heat in the backlight chassis 91 is transmitted through the highly rigid and highly thermally conductive member 912 in a perpendicular direction to be radiated from a rear surface of the highly rigid and highly thermally conductive member 912.

Furthermore, since the LED 121 generates most heat, it is desirable that the highly rigid and highly thermally conductive member 912 be provided at a part of the backlight chassis 91 with which the LED substrate 122 on which the LED 121 is fixed comes in contact. Specifically, with the highly rigid and highly thermally conductive member 912 provided as shown in FIG. 12, heat generated from the LED 121 is transmitted to the LED substrate 122 and is then transmitted therefrom to the highly rigid and highly thermally conductive member 912 and through the highly rigid and highly thermally conductive member 912 in the perpendicular direction to be radiated from the rear surface of the highly rigid and highly thermally conductive member 912.

Even in a case where the LED substrate 122 is fixed on the resin member 911, heat generated from the LED 121 is transmitted to the LED substrate 122 and is then transmitted therefrom to the resin member 911. The heat is then transmitted through the surface of the resin member 911 in a plane direction while being radiated to some extent. The heat is further transmitted to the highly rigid and highly thermally conductive member 912 and through the highly rigid and highly thermally conductive member 912 in the perpendicular direction to be radiated from the rear surface of the highly rigid and highly thermally conductive member 912.

The backlight chassis 91 can be manufactured by a method similar to the method used for the foregoing backlight chassis 11, in which case similar effects can provided. Furthermore, the embodiments shown in FIGS. 4 to 10 can be applied also to the liquid crystal display device 90 described here, in which case similar effects can be provided.

A through opening may be provided at each of regions 913 enclosed by the highly rigid and highly thermally conductive member 712, which are shown in FIG. 13. With the opening provided, the use amount of the resin member 911 can be reduced by an amount defined by the opening, and thus further weight reduction can be achieved.

### INDUSTRIAL APPLICABILITY

The present invention can be applied to a backlight chassis on which a light source is mounted in either of a case where the direct method is adopted and a case where the edge light method is adopted.

### LIST OF REFERENCE SYMBOLS

10, 90 liquid crystal display device

12 light source unit

11, 21, 31, 41, 51, 61, 71, 81, 91 backlight chassis

111, 211, 311, 411, 511, 611, 711, 811, 911 resin member

112, 212, 312, 412, 512, 612, 712, 812, 912 highly rigid and highly thermally conductive member

121 LED

212a convex portion

312a concave portion

613, 713 opening

1. A backlight chassis for mounting a light source unit thereon, comprising in combination:
a resin member; and
a highly rigid and highly thermally conductive member having higher rigidity and higher thermal conductivity than those of the resin member.

2. The backlight chassis according to claim 1, wherein
the highly rigid and highly thermally conductive member is provided at a part of the backlight chassis with which the light source unit comes in contact.

3. The backlight chassis according to claim 1, wherein
the highly rigid and highly thermally conductive member is provided so as to penetrate through the backlight chassis.

4. The backlight chassis according to claim 3, wherein
a surface of the highly rigid and highly thermally conductive member exposed to an outer side of the backlight chassis is formed so as to be in a fin configuration.

5. The backlight chassis according to any claim 1, wherein
an LED is used as a light source of the light source unit.

6. The backlight chassis according to claim 1, wherein
the light source unit is disposed based on a direct method or an edge light method.

7. The backlight chassis according to claim 1, wherein
a concave portion or a convex portion is provided on a joint surface between the highly rigid and highly thermally conductive member and the resin member, and
the highly rigid and highly thermally conductive member is molded integrally with the resin member.

8. The backlight chassis according to claim 1, wherein
the highly rigid and highly thermally conductive member is bend-processed.

9. The backlight chassis according claim 1, wherein
the highly rigid and highly thermally conductive member is provided at least in a shape formed along an outer periphery of a bottom surface of the backlight chassis.

10. The backlight chassis according to claim 1, wherein
the highly rigid and highly thermally conductive member is disposed in a striped lattice form.

11. The backlight chassis according to claim 1, wherein
an opening is provided at a region enclosed by the highly rigid and highly thermally conductive member.

12. A liquid crystal display device comprising the backlight chassis according to claim 1.
